(19) United States
(12) Patent Application Publication
(10) Pub. No.: US 2022/0100190 A1
(43) Pub. Date: Mar. 31, 2022

(54) Method For Operating A Motor Vehicle As A Road User On A Road And Motor Vehicle

(71) Applicant: Volkswagen Aktiengesellschaft, Wolfsburg (DE)

(72) Inventors: Daniel Münning, Braunschweig (DE); Lukas Ackert, Frellstedt (DE)

(73) Assignee: Volkswagen Aktiengesellschaft, Wolfsburg (DE)

(21) Appl. No.: 17/485,649

(22) Filed: Sep. 27, 2021

(30) Foreign Application Priority Data
Sep. 28, 2020 (DE) 10 2020 212 141.9

(51) Int. Cl. G05D 1/00; B60W 50/16; B60W 30/095

(52) U.S. Cl. CPC G05D 1/0088; B60W 2050/146; B60W 30/0956; B60W 50/16

(57) ABSTRACT

The present invention relates to a method for operating a motor vehicle as a first road user on a road, comprising: obtaining information on the current and/or a possible future traffic situation on the road; determining, based on the obtained information, whether a deviation from the present travel and/or steering direction or from a navigation destination on the road is appropriate according to a predefined criterion in order to clear the way for a second road user directly or indirectly via third road users, and if yes: determining a new destination on or at the side of the road, determining whether it is necessary to drive onto an obstacle in order to reach the new destination, and if yes, checking whether an adjustment of the chassis of the motor vehicle is compatible with driving onto the obstacle, and if yes, prompting the motor vehicle to head for the new destination.

### CROSS-REFERENCE TO RELATED APPLICATIONS

This application claims priority to German Patent Application No. DE 10 2020 212 141.9, filed on Sep. 28, 2020 with the German Patent and Trademark Office. The contents of the aforesaid patent application are incorporated herein for all purposes.

### TECHNICAL FIELD

The present invention relates to a method for operating a motor vehicle as a road user on a road. It also relates to a corresponding motor vehicle that uses the method.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

It is possible for a motor vehicle to comprise an adjustable chassis and to be accordingly adaptable to the conditions of the roadway, wherein the chassis may be spontaneously adjusted for example during travel, and specifically either by the vehicle driver (driver) by means of a corresponding input on an input apparatus or autonomously by the motor vehicle in a manner controlled by means of a corresponding data processing apparatus (control apparatus). Adjustable chassis may be generally known. The invention may be used both in driver-driven vehicles and also in partially autonomous driving vehicles, if applicable also in future fully autonomously driving vehicles.

Any traffic situation, for example when traveling on a clear road or in stop-and-go mode, may change very quickly. A typical case in which the driver or the vehicle must react quickly is during the approach of an emergency vehicle (an ambulance, fire truck, or police car), to which said driver or vehicle must give way in accordance with the applicable laws or customary traffic practice. The vehicle driver, who is thrown out of a state of concentration, must react quickly and move the vehicle to the side.

### SUMMARY

A need exists to provide a manner in which a motor vehicle may be operated such that it may clear the way quickly for another road user.

The need is addressed by a method and a motor vehicle according to the independent claims. Embodiments of the invention are described in the dependent claims, the following description, and the drawings.

### BRIEF DESCRIPTION OF THE DRAWINGS

FIG. 1 shows a traffic situation in which an embodiment of a motor vehicle is carrying out an exemplary method; and

FIG. 2 shows a flow chart for illustrating the steps of an exemplary embodiment.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In a first exemplary aspect, a method for operating a motor vehicle as a first road user on a road thus starts with a step of obtaining information on the current and/or a possible future traffic situation on the road. Here, the term “information” comprises certain content categories being fulfilled. As such, “traffic situation” is not necessarily described by an exact indication of positions of other road users, but rather may also be expressed by the rough indication of “other motor vehicle on adjacent lane” or “other motor vehicle at a distance of between 150 m and 75 m”, and the like, without limitation. The method in some embodiments thus involves determining, by means of suitable unit(s) or circuit(s) of the motor vehicle based on the obtained information, whether a deviation from the present travel and/or steering direction or from a navigation destination on the road is appropriate according to a predefined criterion in order to clear the way for a second road user directly, or indirectly via third road users, whose way is cleared such that they themselves may move aside in order to clear the way for the second road user. The predefined criterion may be in some embodiments that a predefined type of second road user (for example one having priority over the motor vehicle itself to drive on the road) is at a predefined minimum distance and/or is approaching at a defined minimum speed that is above a limit, or is issuing a signal (blue lights), and the like, without limitation. A deviation from the present direction of travel may be appropriate if the second road user is in close proximity. This also applies to a deviation from a steering direction. A relatively far-away navigation destination for which the motor vehicle is heading by means of a navigation system thereof, for example, may be in such a location that the second road user would be hindered were the journey to said navigation destination to be pursued. In this case, navigation may be interrupted or terminated as a precaution in the event of an approaching second road user who is not yet directly visible. In some embodiments, a new destination on or at the side of the road may also be determined. This new destination should for example differ qualitatively from a conventional navigation destination in that it may be reached by the motor vehicle within a distance of, for example, 200 m, 100 m, at most 50 m, within 25 m, or at most 10 m. In some embodiments, a checking step is provided of determining whether it is necessary to drive onto an obstacle in order to reach the new destination. If this is not the case, the motor vehicle is immediately prompted to drive to the new destination. However, if this is the case and in some embodiments, it is checked whether an adjustment of the chassis of the vehicle is compatible with driving onto the obstacle. This may for example depend on the height of a curb and the current chassis settings. If chassis adjustment is compatible with the obstacle, the motor vehicle is immediately prompted to head for the new destination, otherwise the driver is for example informed of the obstacle (e.g., pop-up information). The driver may then, under certain circumstances, be able to forego reaching the new destination. In the case of an adjustable chassis, the driver may in some embodiments actively adapt to the obstacle (via an available input apparatus). The chassis may, under certain circumstances, also be adjusted autonomously in some embodiments. When the result of the two checking steps is positive, i.e., with regard to the existence of an obstacle and the vehicle's suitability for the obstacle, the method according to some embodiments ends such that the motor vehicle heads for the new destination.

The second road user may be any vehicle with priority (for example a high-ranking politician or the like), but it is typically an ambulance, fire truck, or police car. Said vehicles are acoustically recognizable within the audible frequency range (on account of their sirens), for example the tone interval contained therein. Ultrasonic detection (for example based on certain speed profiles) is also possible in some embodiments. A second road user of this kind may also be recognized optically (by the blue lights, etc.; by means of a camera with downstream image recognition, or based on typical profiles in the spectrum by infrared or ultraviolet) in some embodiments. Finally, the second road user may alternatively or additionally and in some embodiments issue additional signals (wirelessly, for example via radio) that may be received by a corresponding receiving device on the motor vehicle and, equally, third road users may transmit information on the second road user to the motor vehicle as the first road user via so-called car-to-car communication. In modern traffic control systems, stationary units that monitor the traffic volume and that may be designed to recognize specific road users such as ambulances, fire trucks, and police cars are provided at the side of the road. Stationary units of this kind may inform the motor vehicle in some embodiments as the first road user of the approach of the second road user wirelessly. Furthermore, (aerial) drones or other flying objects may also monitor the traffic situation in some embodiments. Finally, it is known to transmit traffic information to a motor vehicle via satellites. Satellites of this kind may provide, inter alia, so-called swarm data: Every or almost every motor vehicle transmits their location to a central apparatus (for example via satellite), which then evaluates the data and transmits corresponding information back to the motor vehicles.

The step of prompting the motor vehicle to head for the new destination may include in some embodiments at least issuing a signal to the driver in order to recommend the new destination. In this way, the driver remains in control, may assess the traffic situation for themselves, and if applicable decide otherwise, but generally said driver will follow the driving recommendation.

A recommendation of this kind may be given by means of an acoustic voice prompt that gives details about the new destination in some embodiments (“Please drive onto the curb on the right to clear the way”) and/or it may include an acoustic and/or haptic signal (the latter on the steering wheel) in order to attract the driver's attention such that said driver reads details about a new direction of travel and/or about the new destination from a display. Accordingly, optical signaling that is coupled to the display may additionally or alternatively take place in some embodiments (special lamp). The display may be provided outside of normal navigation in some embodiments, i.e., it may involve a special region on the dashboard that is otherwise used for other purposes or the like, or it may be integrated into ongoing navigation, wherein a change occurs in the display during ongoing navigation (e.g.: blue or red arrows instead of white arrows, or the like). If applicable, navigation may be activated spontaneously in some embodiments. Furthermore, the driver may be guided as to where to steer the vehicle by means of haptic signals on the steering device of the motor vehicle in some embodiments. For example, a partially vibrating steering wheel may discourage the driver from touching the corresponding points and thus turning the steering wheel, or the like. Finally, modern systems such a glasses worn by the driver or wearables worn by the driver may be used, which are coupled to a transceiver apparatus of the vehicle via a wireless connection (Bluetooth® or the like).

As an alternative to issuing a driving recommendation, it is possible in some embodiments for the motor vehicle to be driven autonomously to the new destination. The autonomous driving may additionally be switched on if the driver does not react at all or reacts in such a way that could endanger road safety in some embodiments.

In parallel to the issuing of recommendations to the destination or the autonomous driving and in some embodiments, the chassis may either be suitably adjusted automatically or be suitably adjusted in response to a corresponding input by the driver on the basis of a recommendation. For the recommendation, the driver may be given an optical, acoustic, or haptic signal.

A second exemplary aspect concerns a motor vehicle that comprises a circuit (also herein referred to as ‘apparatus’) for obtaining information on the current and/or a possible future traffic situation on a road traveled on by the motor vehicle, a circuit (also herein referred to as ‘apparatus’) for acquiring information on the roadway and/or road boundaries in the surroundings of the motor vehicle, and a data processor (also herein referred to as ‘processing apparatus’), which is configured to receive information obtained by the circuit for obtaining information and to evaluate said information according to a predefined criterion with regard to the approach of another road user for whom the way should be cleared, wherein the data processor determines, based on the information obtained by the acquiring circuit, which new destination should be headed for such that the way may be cleared for the other road user. If the other road user is approaching, the circuit for acquiring information on the roadway and/or road boundaries in the surroundings of the motor vehicle is activated or, if the circuit is already active, the querying of the information/measured values obtained, etc., is activated. The data processor is also configured to evaluate the information acquired on the roadway and/or road boundaries in the surroundings of the motor vehicle with regard to whether there is an obstacle in the surroundings and whether the chassis is compatible with driving onto the obstacle, and it is also configured to prompt a course to be set for the new destination if this is the case.

For example, the motor vehicle comprises an adjustable chassis that may be adapted to obstacles (for example curbs).

The circuit for acquiring information on the roadway and/or road boundaries in the surroundings of the motor vehicle is for example provided by: at least one front camera and/or at least one side camera and/or at least one ultrasonic sensor and/or at least one laser scanner and/or at least one radar sensor, the signals of which may be used to obtain information on the height of a curb. Apparatuses of this kind are generally already present in motor vehicles, and therefore only additional software is required in the data processor in order to evaluate the signals specifically for the purpose of obtaining the information on the height of the curb. Alternatively and in some embodiments, apparatuses of this kind may be provided specifically and exclusively for the purpose of obtaining the information on the height of the curb, such that the motor vehicle may react particularly quickly. In this case, too, the adjustable chassis is either adapted automatically or based on a driver input. In the latter case, the vehicle comprises means for outputting a driving recommendation to a driver of the motor vehicle, which means are activated if the other road user is approaching. In this case, means that are already present in the motor vehicle may for example be used: a loudspeaker for an acoustic voice prompt or a loudspeaker for an acoustic signal, in conjunction with a display. A loudspeaker may be substituted for or supplemented by a vibrating actuator. A lamp may generally attract the attention of the driver and be coupled to a display that shows the new direction of travel. For example, the already-present navigation system of a motor vehicle may be used, and if applicable suitably adapted (option to display in other colors: blue or red to display a special driving situation). A vibrating actuator may be provided on a steering device of the motor vehicle. The recommendation may be given to the driver by means of glasses worn by the driver or a wearable worn by the driver or both, for which purpose a corresponding transceiver apparatus is to be provided in the motor vehicle for wired or wireless communication with the glasses or wearable.

The circuit for obtaining information may in some embodiments operate acoustically, optically, or generally wirelessly in diverse frequency ranges of the electromagnetic spectrum. As such, it is possible for the information to be acquired from other units such as stationary units at the side of a road, drones and/or satellites, or from other road users. The information may also be directly derived from signals issued by the other road user (e.g.: interval detection in the case of a siren or the like).

Reference will now be made to the drawings in which the various elements of embodiments will be given numerical designations and in which further embodiments will be discussed.

In the exemplary embodiments described herein, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

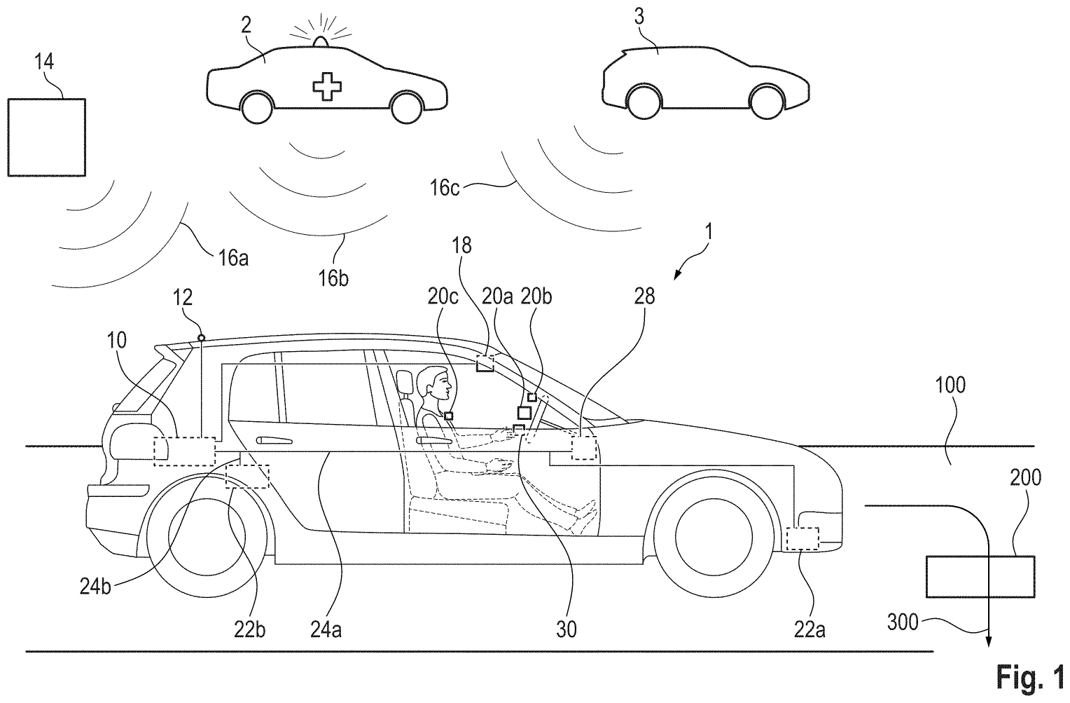

A motor vehicle denoted as a whole by 1 in FIG. 1 is driving as the first road user on a road 100. In the method, the motor vehicle 1 is to clear the way for a second road user 2 such as an ambulance or the like. The way may be cleared directly for the ambulance 2 or for a third road user 3 who would otherwise be in the way of the ambulance 2.

In the method, a new destination 300 that leads the vehicle over the edge of a curb 200 is determined for the vehicle 1. For these purposes, the motor vehicle 1 is equipped as follows:

A central data processor 10 (“control apparatus”) processes the data of all sensors and actuates all actuators of the motor vehicle 1. A first sensor group 12 acquires signals from external units 14 such as stationary units at the side of a road (namely at the side of the road 100 itself or at the side of another road), satellites, drones or the like, wherein said information is received via a wireless path 16a (“radio”). Equally, the sensor group 12 may also receive information from the second road user 2 via a wireless path 16b and from at least one third road user 3 via a wireless path 16c. The data processor 10 evaluates the information received by means of the sensor group 12 in order to detect the approach of the second road user 2. The data processor 10 comprises suitable software that implements predefined criteria according to which it is determined whether or not the motor vehicle 1 should give way to the approaching second road user 2. If this is the case, the new destination 300 is determined based on navigation data already present in the motor vehicle (if applicable via the sensor group 12). It is checked, by means of a (sensor) apparatus 18 for acquiring information on the roadway 100 and/or on the road boundaries 200, whether an obstacle, for example a curb, must be overcome in order to reach the new destination 300. Said apparatus 18 may be designed as a front camera, ultrasonic scanner, laser scanner, or radar scanner. Merely by way of example, it is shown here at the top of the motor vehicle, but it may also be divided into multiple units and/or be placed at different locations on the motor vehicle. The information that there is another road user, such as the second road user 2, for whom the way must be cleared and also relating to the new destination 300 for which a course should for example be set is provided to a driver of the motor vehicle 1 via a suitable output apparatus 20a (loudspeaker, lamp, display, vibrating alarm, etc.). The information obtained by the apparatus 18 for acquiring information on the roadway and/or road boundaries is processed by the data processor 10 such that it may be checked whether the new destination 300 may only be reached via a curb 200 that requires the chassis 22a, 22b to be adapted. If this is the case, the driver is recommended via a corresponding output apparatus 20b (which may be identical to the output apparatus 20a at least in parts, unlike what is shown in FIG. 1) to adapt the chassis 22a, 22b by actively operating an input apparatus 30, wherein corresponding control commands are then issued to the chassis 22a, 22b by the data processor 10 via control lines 24a, 24b. Alternatively, it is possible for the vehicle to be controlled to the new destination 300 autonomously by an apparatus 28, wherein the apparatus 28 also directly adapts the chassis 22a, 22b, if applicable.

The output apparatuses 20a and/or 20b may cooperate wirelessly with wearables 20c worn on the body of the driver such that said wearables issue the output signals to the driver, for example via a vibrating alarm.

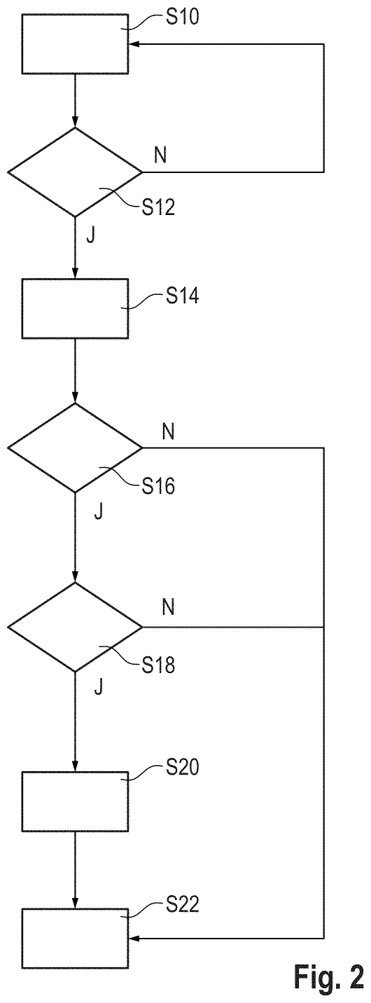

FIG. 2 illustrates an exemplary embodiment by means of a flow chart. Here, the motor vehicle is assumed to have an adjustable chassis. If the motor vehicle chassis is not adjustable, discrepancies occur at the steps S18 and S20.

Initially, in step S10, normal operation of the motor vehicle, in which information on the current and/or a possible future traffic situation on the road is continuously obtained, is represented. According to step S12, it is determined whether a deviation from the present travel and/or steering direction or from a navigation destination on the road is appropriate according to a predefined criterion in order to clear the way for the second road user 2 directly or indirectly via third road users 3. If the result of this determination is negative, the process starts again at step S10. If a predefined type of second road user is approaching in a predefined situation and thus the predefined criterion is met, a transition is made to step S14: According to step S14, a new destination 300 on or at the side of the road is determined. Then, in step S16, it is determined whether it is necessary to drive onto an obstacle such as the curb 200 in order to reach the new destination 300. If this is not the case, a transition is immediately made to step S22, otherwise to step S18. In step S18, it is checked whether the chassis 22a, 22b of the motor vehicle 1 must be adapted to the obstacle 200. If this is not the case, a transition is immediately made to step S22, otherwise to step S20, according to which the chassis 22a, 22b is adapted (via the output apparatus 20b and the input apparatus 30, or autonomously). Then, in step S22, the motor vehicle is prompted to head for the new destination 300 (by means of the output apparatus 20a and input apparatus 30, or autonomously by means of the corresponding apparatus 28).

As a result, in a stressful situation in which a second vehicle such an ambulance is approaching, the driver is suitably assisted with carrying out the evasion procedure by the invention by suitable technical means.

### LIST OF REFERENCE NUMERALS

1 Motor vehicle
2 Second road user
3 Third road user
10 Central data processor
12 First sensor group
14 External unit
16a Wireless path
16b Wireless path
16c Wireless path
18 Apparatus for acquiring information
20a Output apparatus
20b Output apparatus
20c Wearable
22a Chassis
22b Chassis
24a Control line
24b Control line
28 Apparatus for autonomous driving
30 Input apparatus
100 Road
200 Obstacle
300 Destination
S10 Method step
S12 Method step
S14 Method step
S16 Method step
S18 Method step
S22 Method step

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for operating a motor vehicle as a first road user on a road, comprising:
obtaining information on one or more of a current and a possible future traffic situation on the road;
determining, based on the obtained information, whether a deviation from the present travel and/or steering direction or from a navigation destination on the road is appropriate according to a predefined criterion in order to clear the way for a second road user directly or indirectly via third road users; and if the deviation is appropriate:
determining a new destination on or at the side of the road;
determining whether it is necessary to drive onto an obstacle in order to reach the new destination; and if this is the case:
checking whether an adjustment of the chassis of the motor vehicle is compatible with driving onto the obstacle; and if this is the case:
prompting the motor vehicle to head for the new destination.

2. The method of claim 1, wherein the driver is informed, using optical, acoustic and/or haptic signals, that it is not possible to drive over the obstacle if the adjustment of the chassis is not compatible with driving onto the obstacle.

3. The method of claim 2, wherein the driver is also informed by the signals of the possibility to adapt the chassis to the obstacle by providing a corresponding input.

4. The method of claim 1, wherein the chassis of the motor vehicle is suitably adjusted automatically.

5. The method of claim 1, wherein the second road user is an ambulance, a fire truck, or a police car, and in that, during obtaining information, the information of the second road user approaching is obtained acoustically within the audible frequency range and/or by ultrasound and/or optically and/or by infrared and/or by ultraviolet and/or based on signals from the second and/or third road users and/or based on signals from stationary units at the side of a road and/or from drones and/or satellites.

6. The method of claim 1, wherein the step of prompting the motor vehicle to head for the new destination comprises at least issuing a signal to the driver in order to recommend the new destination.

7. The method of claim 6, wherein the recommendation is given to the driver using at least one of the following:
an acoustic voice prompt that gives details about the new destination;
an acoustic and/or haptic signal in order to attract the driver's attention in conjunction with a visual detail display of a new direction of travel and/or of the new destination on a display;
optical signaling in order to attract the driver's attention in conjunction with a visual detail display of a new direction of travel and/or of the new destination on a display outside of normal navigation;
a visual detail display of a new direction of travel and/or of the new destination on a display integrated into ongoing or spontaneously activated new navigation;
haptic signals on a steering device of the motor vehicle; and
signals on glasses worn by the driver or wearables worn by the driver.

8. A motor vehicle comprising:
a circuit for obtaining information on a current and/or a possible future traffic situation on a road traveled on by the motor vehicle;
a circuit for acquiring information on a roadway and/or road boundaries in the surroundings of the motor vehicle;
a data processor, which is configured to receive the information obtained by the circuit for obtaining information and to evaluate said information according to a predefined criterion with regard to the approach of another road user for whom the way should be cleared;
wherein the data processor determines, based on the information obtained by the circuit for acquiring, which new destination should be headed for such that the way may be cleared for the other road user, wherein, if the other road user is approaching, the circuit for acquiring information on the roadway and/or road boundaries in the surroundings of the motor vehicle is activated or querying thereof is activated, and wherein the data processor is configured to evaluate the information acquired on the roadway and/or road boundaries in the surroundings of the motor vehicle with regard to whether there is an obstacle and whether an adjustment of the chassis is compatible with driving onto the obstacle, wherein the data processor is also configured to prompt a course to be set for the new destination if this is the case.

9. The motor vehicle of claim 8, wherein the circuit for acquiring information on the roadway and/or road boundaries in the surroundings of the motor vehicle is provided by: at least one front camera and/or at least one side camera and/or at least one ultrasonic sensor and/or at least one laser scanner and/or at least one radar sensor, the signals of which may be used to obtain information on the height of a curb.

10. The motor vehicle of claim 8, wherein the motor vehicle comprises an adjustable chassis that may be adapted to obstacles.

11. The motor vehicle of claim 10, wherein the adjustable chassis is automatically adapted to a new destination determined for the purpose of clearing the way.

12. The motor vehicle of claim 10, wherein the data processor causes at least a signal to be output to a driver of the motor vehicle in order to prompt said driver to adjust the chassis by driver input and, after receiving such a driver input, causes the chassis to be adapted to a new destination determined for the purpose of clearing the way.

13. The motor vehicle of claim 8, wherein an output for a driving recommendation to a driver of the motor vehicle is activated if the other road user is approaching.

14. The motor vehicle of claim 13, wherein the recommendation is given to the driver using at least one of the following:
a loudspeaker, which outputs an acoustic voice prompt that gives details about the new destination;
a loudspeaker for an acoustic signal and/or a vibrating actuator for a haptic signal in order to attract the driver's attention in conjunction with a display for the visual detail display of a new direction of travel and/or of the new destination;
a lamp for optical signaling in order to generally attract the driver's attention in conjunction with a display outside of normal navigation for the visual detail display of a new direction of travel;
a display, which is used during navigation in the motor vehicle for the visual detail display of a new direction of travel;
a vibrating actuator on a steering device of the motor vehicle for generating haptic signals; and
glasses worn by the driver and/or wearables worn by the driver in conjunction with a transceiver device of the motor vehicle for this purpose.

15. The motor vehicle of claim 8, wherein the circuit for obtaining information acquires the information based on acoustic signals within the audible frequency range and/or by ultrasound and/or based on optical signals and/or by infrared and/or by ultraviolet and/or based on signals from other road users and/or based on signals from stationary units at the side of a road and/or from drones and/or satellites.

16. The method of claim 2, wherein the chassis of the motor vehicle is suitably adjusted automatically.

17. The method of claim 2, wherein the second road user is an ambulance, a fire truck, or a police car, and in that, during obtaining information, the information of the second road user approaching is obtained acoustically within the audible frequency range and/or by ultrasound and/or optically and/or by infrared and/or by ultraviolet and/or based on signals from the second and/or third road users and/or based on signals from stationary units at the side of a road and/or from drones and/or satellites.

18. The method of claim 3, wherein the second road user is an ambulance, a fire truck, or a police car, and in that, during obtaining information, the information of the second road user approaching is obtained acoustically within the audible frequency range and/or by ultrasound and/or optically and/or by infrared and/or by ultraviolet and/or based on signals from the second and/or third road users and/or based on signals from stationary units at the side of a road and/or from drones and/or satellites.

19. The method of claim 4, wherein the second road user is an ambulance, a fire truck, or a police car, and in that, during obtaining information, the information of the second road user approaching is obtained acoustically within the audible frequency range and/or by ultrasound and/or optically and/or by infrared and/or by ultraviolet and/or based on signals from the second and/or third road users and/or based on signals from stationary units at the side of a road and/or from drones and/or satellites.

20. The method of claim 2, wherein the step of prompting the motor vehicle to head for the new destination comprises at least issuing a signal to the driver in order to recommend the new destination.
